(19) United States
(12) Patent Application Publication
(10) Pub. No.: US 2025/0267031 A1
(43) Pub. Date: Aug. 21, 2025

(54) HOME AUTOMATION TRAINING SYSTEM

(71) Applicant: Alarm.com Incorporated, Tysons, VA (US)

(72) Inventors: Michael Kelly, Washington, DC (US); Donald Gerard Madden, Columbia, MD (US); Daniel Todd Kerzner, McLean, VA (US)

(21) Appl. No.: 19/051,286

(22) Filed: Feb. 12, 2025

Related U.S. Application Data
(60) Provisional application No. 63/554,387, filed on Feb. 16, 2024.

(51) Int. Cl. H04L 12/28

(52) U.S. Cl. CPC H04L 12/2827; H04L 12/282

(57) ABSTRACT

Methods, systems, and apparatus, including computer programs encoded on computer storage media, for training using an automated system. One of the methods includes determining, using first sensor data obtained by a sensor at a property, that a candidate target object satisfies a similarity threshold for each of two or more predetermined objects; in response to determining that the candidate target object satisfies the similarity threshold, accessing second sensor data of the candidate target object; determining, using at least the second sensor data, that the candidate target object is a target object from the two or more predetermined objects; in response to determining that the candidate target object is the target object, selecting, from a plurality of automated actions each for a corresponding one of the two or more predetermined objects, an automated action; and performing the automated action.

### CROSS-REFERENCE TO RELATED APPLICATION

This application claims the benefit of U.S. Provisional Application No. 63/554,387, filed Feb. 16, 2024, which is incorporated by reference.

### BACKGROUND

This disclosure application relates generally to property monitoring systems.

A property monitoring system can use one or more sensors to continuously capture data near a property, such as images or videos of a scene. The property monitoring system performs analysis of the sensor data, e.g., using various computer vision methods to determine whether there is an object of interest in the captured image or video.

### SUMMARY

The disclosed systems and methods relate to property monitoring systems. Some property monitoring systems enable a person, e.g., a home or business owner, to monitor various portions of their property. This can include providing a video feed to a device operated by the person.

However, these systems use computational resources to provide this functionality. For instance, a property monitoring system uses network bandwidth to transmit video to the device. Further, the property monitoring system can use memory, e.g., on a device included in the system, to buffer and stream the video to the device. And if the device is battery operated, the device needs to use battery power during the transmission.

A property monitoring system can automatically monitor various activities at the property and perform an automated action. For instance, the property monitoring system can determine an activity that likely occurred at the property and a corresponding action to perform given the activity. In some examples, the property monitoring system can be an automated behavior training system that detects undesirable or desirable behaviors and performs automated actions to deter the undesirable behaviors, to reinforce the desirable behaviors, e.g., to train a pet, or a combination of both.

This can be particularly difficult when the action performed can vary given the target object associated with the activity and the property monitoring system has difficulty distinguishing between the target objects. For instance, the property monitoring system might perform a different action given a vehicle or a pet that participates in the activity but multiple vehicles or pets at the property can be difficult to distinguish between, e.g., when they are of similar types.

The property monitoring system can detect a target object, e.g., a pet, a toddler, or an older adult, who is performing a target behavior, e.g., being in a restricted area. The property monitoring system can automatically perform a deterrence or reinforcement action on the target object. The automatic action can include audio cues, visual cues, giving a pet a treat, other appropriate actions, or a combination of these. The property monitoring system can dynamically vary the deterrence or reinforcement action using context information. The system can use machine learning to test various candidate actions and to learn individualized training methods for each pet or person.

In general, one aspect of the subject matter described in this specification can be embodied in methods that include the actions of determining, using first sensor data obtained by a sensor at a property, that a candidate target object satisfies a similarity threshold for each of two or more predetermined objects; in response to determining, using the first sensor data obtained by the sensor at the property, that the candidate target object satisfies the similarity threshold for each of the two or more predetermined objects, accessing second sensor data of the candidate target object; determining, using at least the second sensor data of the candidate target object, that the candidate target object is a target object from the two or more predetermined objects; in response to determining that the candidate target object is the target object, selecting, from a plurality of automated actions each for a corresponding one of the two or more predetermined objects, an automated action; and performing the automated action for the target object.

In general, one aspect of the subject matter described in this specification can be embodied in methods that include the actions of maintaining first data representing a predetermined behavior for a target object that was determined using historical sensor data obtained by one or more sensors at a property; maintaining second data representing an action that (i) was performed within a threshold time of the predetermined behavior of the target object, and (ii) was predicted to satisfy a correlation threshold that indicates that the action was likely performed as a result of the predetermined behavior; detecting, using sensor data obtained by a sensor at the property, the target object; determining, using the sensor data and the first data, that a behavior of the target object satisfies a similarity criterion for the predetermined behavior for the target object; and in response to determining that the behavior of the target object satisfies the similarity criterion for the predetermined behavior, causing, using the second data, performance of an automated action that represents the action that was performed within the threshold time of the predetermined behavior of the target object.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, the method can include detecting an action performed by the candidate target object. Determining, using the first sensor data, that the candidate target object satisfies the similarity threshold for each of two or more predetermined objects can be responsive to detecting the action performed by the candidate target object.

In some implementations, the first sensor data can have a first resolution. Accessing the second sensor data of the candidate target object can include accessing the second sensor data that has a second resolution that is different than the first resolution of the first sensor data. Determining that the candidate target object is the target object from the two or more predetermined objects can use at least the second sensor data that has the second resolution that is different than the first resolution of the first sensor data.

In some implementations, the first sensor data can include the second sensor data and third sensor data. Accessing the second sensor data of the candidate target object can include: selecting, as the second sensor data, a proper subset of the first sensor data; and determining to skip selecting the third sensor data. Determining that the candidate target object is the target object from the two or more predetermined objects can use the second sensor data that is the proper subset of the first sensor data and does not use the third sensor data.

In some implementations, determining that the candidate target object satisfies the similarity threshold for each of the two or more predetermined objects can use a first detection model. Determining that the candidate target object is the target object from the two or more predetermined objects can use a second, different detection model that is a different model from the first detection model.

In some implementations, the first detection model can be trained to differentiate different types of objects than the second, different detection model.

In some implementations, performing the automated action for the target object can include: determining that a behavior of the target object satisfies a similarity criterion for a predetermined behavior for the target object; and in response to determining that the behavior of the target object satisfies a similarity criterion for the predetermined behavior, causing performance of a training action corresponding to the predetermined behavior on the target object.

In some implementations, determining that the candidate target object is the target object from the two or more predetermined objects can include: determining, using at least the second sensor data of the candidate target object, whether the candidate target object is the target object from the two or more predetermined objects; and determining that the candidate target object is the target object from the two or more predetermined objects.

In some implementations, the method can include: detecting, using first sensor data, behavior by the target object at a first time; detecting, using second sensor data, the action performed by a person at the property within the threshold time of the first time; in response to detecting the action performed by the person at the property within the threshold time of the first time, predicting that the action and the behavior satisfy the correlation threshold; and in response to predicting that the action and the behavior satisfy the correlation threshold, updating the first data, the second data, or both, to include association data that associates the behavior with the action.

In some implementations, the method can include detecting a response by the target object after the action was performed by the person at the property; and determining, using the response, whether the action performed by the person satisfies a threshold effectiveness criterion. Updating the first data, the second data, or both, can be responsive to determining that the action performed by the person satisfies a threshold effectiveness criterion.

In some implementations, determining, using the response, whether the action performed by the person satisfies a threshold effectiveness criterion can be responsive to predicting that the action and the behavior satisfy the correlation threshold.

In some implementations, the method can include receiving data indicating user input defining a region of interest for analysis. Detecting the behavior by the target object at the first time can use the region of interest.

In some implementations, the method can include determining third data defining a region of interest; determining fourth data defining a rule for the region of interest that indicates either an allowed behavior or behavior that should be prevented; determining fifth data indicating an action to perform upon detection of the allowed behavior or the behavior that should be prevented; updating the first data using the third data and the fourth data; and updating the second data using the fifth data.

In some implementations, the sensor comprises a moveable sensor, the operations can include: detecting movement of a person at the property; determining to change a location of the moveable sensor at the property in response to detecting the movement of the person at the property; and sending, to a device, an instruction to cause the change to the location of the moveable sensor at the property.

In some implementations, detecting the movement of the person at the property can include determining that the person left an area at the property. Determining to change the location of the moveable sensor at the property can be responsive to determining that the person left the area at the property. Sending the instruction can cause the moveable sensor to move to the area of the property. Detecting the target object can include detecting, in the area at the property and using the sensor data obtained by the moveable sensor in the area of the property, the target object.

In some implementations, detecting the target object can include detecting, in an area at the property and using the sensor data obtained by the moveable sensor in the area of the property, the target object. Detecting the movement of the person at the property can include predicting that the person is likely to enter an area at the property. Determining to change the location of the moveable sensor at the property can be responsive to predicting that the person is likely to enter the area at the property. Sending the instruction causes the moveable sensor to leave the area of the property can be performed after detecting the target object using the moveable sensor and before the person is predicted to enter the area at the property.

In some implementations, the area can be a building at the property.

In some implementations, the area can be a room at the property.

In some implementations, sending the instruction can include sending the instruction to a robot to cause the robot to move the moveable sensor from the area at the property.

In some implementations, the method can include determining, using sensor data obtained by a sensor at a property, that a candidate target object satisfies a similarity threshold for each of two or more predetermined objects; in response to determining, using the sensor data obtained by the sensor at the property, that the candidate target object satisfies the similarity threshold for each of the two or more predetermined objects, accessing second sensor data of the candidate target object; determining, using at least the second sensor data of the candidate target object, that the candidate target object is a target object from the two or more predetermined objects; in response to determining that the candidate target object is the target object, selecting, from a plurality of automated actions each for a corresponding one of the two or more predetermined objects, an automated action; and performing the automated action for the target object.

In some implementations, determining that the behavior of the target object satisfies the similarity criterion for the predetermined behavior for the target object can include: determining, using the sensor data and the first data, whether the behavior of the target object satisfies the similarity criterion for the predetermined behavior for the target object; and determining that the behavior of the target object satisfies the similarity criterion for the predetermined behavior for the target object.

The subject matter described in this specification can be implemented in various embodiments and may result in one or more of the following advantages. In some implementations, the property monitoring system can automatically learn the desired or undesired behaviors from historical sensor data that represents human interactions with a target object. The historical sensor data can be data captured by sensors at the property for which the system performs a corresponding action. In some implementations, the property monitoring system can determine the automated actions to train a target object by learning how a person trains the target object. This can reduce computational resource usage because the system need not try a number of different options to determine which action is most likely to work but can instead use data that represents successful actions performed at the property.

In some implementations, the property monitoring system can perform, e.g., precise, detection among two objects that have similar appearance, e.g., two dogs of the same kind, by using high resolution data, using a fine-grained object detection model, or a combination of both. The system can switch between different detection methods to more accurately determine an action to perform at a particular property while reducing computational resource usage. In some implementations, by automatically training a target object, the property monitoring system can save computation, memory, battery, bandwidth, or a combination of these, of a computing device because a device of a property owner does not need to frequently access data for the target object to make sure that the target object is behaving properly.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an example environment with a property monitoring system.

FIG. 2 is a flow diagram of a process for a property monitoring system.

FIG. 3 is a flow diagram of a process for a property monitoring system.

FIG. 4 is a diagram illustrating an example of a property monitoring system.

Like reference numbers and designations in the various drawings indicate like elements.

### DETAILED DESCRIPTION

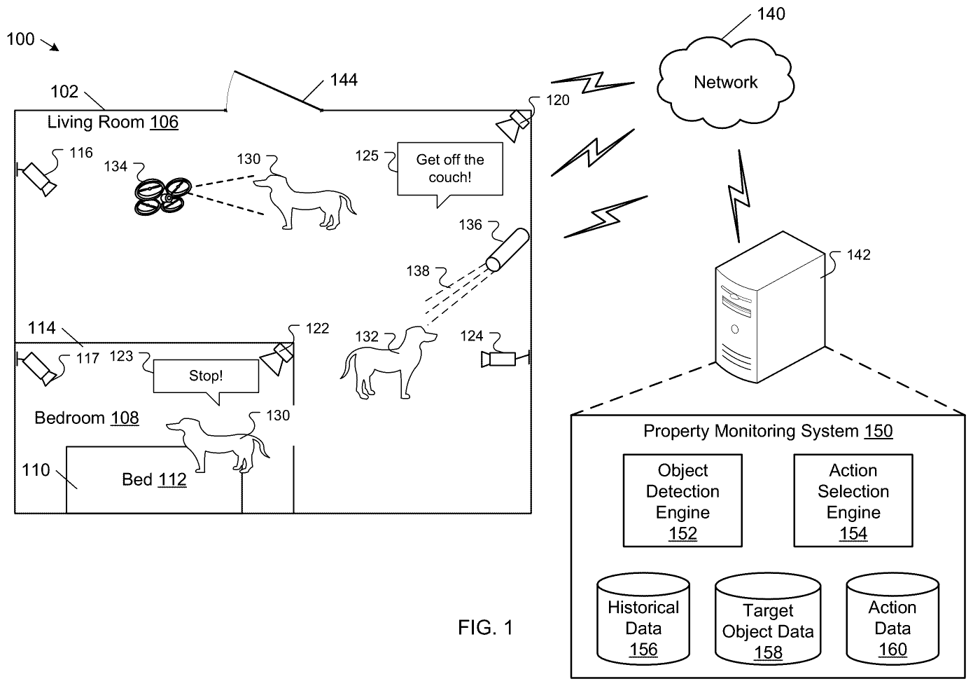

FIG. 1 is a diagram illustrating an example environment 100 with a property monitoring system 150. The property monitoring system 150 includes one or more sensors that monitor a property 102. The one or more sensors can include one or more cameras 116, 117, and 124, a drone 134, an audio sensor, a motion sensor, a wi-fi sensing sensor, a radar, or any combination of these. The property 102 can be a residential property or a commercial property.

The property monitoring system 150 can include an object detection engine 152 that detects an object at the property 102. The property monitoring system 150 can maintain target object data 158 in a database. The target object data 158 includes data for one or more predetermined objects that are monitored by the property monitoring system 150. For example, the target object data 158 can include a list of data items for each pet in the property 102. If there are two dogs 132 and 130 in the property, the target object data 158 can include a first data item for the first dog 130 and a second data item for the second dog 132.

The target object data 158 can include an image, feature vector, text data, or a combination of these, for a corresponding object, e.g., for each predetermined object. The property monitoring system 150 can receive target object data 158 from a user device of a user when the user enrolls the one or more objects. For example, to aid in algorithmic identification, pet owners can flag and label video clips captured by the property monitoring system 150 which depict their pet.

In some implementations, the property monitoring system 150, e.g., the object detection engine 152, can determine, using sensor data, that a candidate target object satisfies a similarity threshold for a predetermined object in the target object data 158. For example, the property monitoring system 150 can determine that a dog 132 detected in a video captured by the camera 124 is likely the dog named Luna using features for Luna that are stored in the target object data 158.

The property monitoring system 150 can automatically monitor various activities at the property 102. In some implementations, the property monitoring system 150 can be an automated behavior training system that detects undesirable or desirable behaviors performed by a predetermined object. The property monitoring system 150 can detect a pet that is in restricted areas or is engaging in unwanted behaviors based on camera data obtained by a camera.

For example, the property monitoring system 150 can detect that a dog 130 is in the bedroom 108 using images or videos obtained by the camera 117 in the bedroom. In some examples, the property monitoring system 150 can detect that the dog 130 is scratching a couch 112 in the living room 106 using data from a camera 116 in the living room 106.

The property monitoring system 150 can perform an automated action in response to determining an activity that occurred at the property. For instance, the property monitoring system can determine an activity that occurred at the property and a corresponding action to perform given the activity. In some implementations, the property monitoring system can be an automated behavior training system that detects undesirable or desirable behaviors and performs automated actions to deter the undesirable behaviors, to reinforce the desirable behaviors, e.g., to train a pet, or a combination of both. By automatically training a target object, the property monitoring system can save computation, memory, battery, bandwidth, or a combination of these, of a computing device or corresponding network because a device of a property owner does not need to more frequently access data for the target object to make sure that the target object is behaving properly as would occur for other systems.

The property monitoring system 150 can include an action selection engine 154 that selects an action to perform. In some implementations, the action selection engine 154 can select an action to perform using the activity performed by the detected target object. The action can include presentation of audio cues, presentation of visual cues, giving a pet a treat, other appropriate actions, or a combination of these. For example, the property monitoring system 150 can detect that the dog 130 is scratching the couch 112, and in response, the property monitoring system 150 can play a recording of the owner of the dog 130 admonishing it or other recognizable sounds that would likely act as a deterrent, such as a recording 125 saying “Get off the couch!”. In some implementations, the automatic action performed by the property monitoring system 150 can be used to deter the target object, reinforce good behavior of the target object, redirect the target object, or a combination of these.

The automatic action performed by the property monitoring system 150 is appropriate to the situation and target. In some implementations, the automatic action performed by the property monitoring system 150 can include presentation of sounds at extreme frequencies, e.g., outside a range of sounds generally detected by humans. Pets can have an auditory range that extends beyond that of humans. Using speaker devices, e.g., a speaker 136, at the property 102 (e.g., panels, smart assistants, connected speakers), the property monitoring system 150 can play sounds at extreme frequencies, e.g., sound 138, that are only audible to animals. These sounds can be used to deter animals from approaching restricted areas when their owners are not around.

In some implementations, the automatic action performed by the property monitoring system 150 can include presentation of other types of sounds. Speakers 120, 122 can play loud sounds that are likely to deter animals from unwanted behaviors. The sounds can include recordings of the owner admonishing the target object or other recognizable sounds that would act as a deterrent. Similarly, the property monitoring system 150 can use audio cues that are likely to reinforce good behavior, such as playing a recording of encouraging words after a puppy successfully uses a pee pad. In some implementations, the property monitoring system 150 can use audio cues to redirect the target object. For example, when the property monitoring system 150 determines that a dog is in a restricted area, the property monitoring system 150 can play audio instructing the dog to go to a designated allowed area, e.g., a dog bed. The property monitoring system 150 can play a recording as a reinforcing reward when the dog goes to the designated allowed area.

In some implementations, the automatic action performed by the property monitoring system 150 can include presentation of visual cues. The system can use light control as an additional training tool. Connected lights can flash repeatedly or change colors as pets engage in restricted activities or enter restricted zones.

In some implementations, the property monitoring system 150 can periodically retest various deterrents as the target object, e.g., a pet, can over time become accustomed to the same deterrent. Similarly, as pets age, their sensitivities to light, sound, or both, may change, and the property monitoring system 150 can perform updates to the automatic actions to make sure deterrents, reinforcers, or both, maintain effectiveness.

The property monitoring system 150 can use one or more of the sensors or other devices at the property 102 to perform the automated action. For instance, a sensor might include a speaker, e.g., as part of a camera, a light, or both. When determining to cause presentation of a sound or flash a light, the property monitoring system 150 can use data that indicates the devices physically located near the object. The property monitoring system 150 can select, from multiple different devices that can perform respective automated actions, a device with which to perform the automated action. In response to selecting the device, the property monitoring system 150 can transmit instructions to the selected device to cause the selected device to perform the corresponding action.

In some implementations, the property monitoring system 150 can determine whether a candidate target object is a target object from two or more predetermined objects. In response to determining that the candidate target object is the target object, the property monitoring system 150 can select an automated action from a plurality of automated actions each for a corresponding one of the two or more predetermined objects. For example, Bernie the dog might be most deterred by playing loud noise and Sandy the cat is most effectively deterred by lights flashing. In response to determining that the candidate target object is Sandy the cat, the system can deter an undesired behavior of Sandy the cat by flashing lights.

In some implementations, the property monitoring system 150 can use a predicted type of a target object to determine an automated action. The predicted type of the target object can be dog, cat, toddler, etc. Each type of object can have a corresponding automatic action. When a dog enters a bedroom, the property monitoring system 150 can present a recording of the owner of the dog admonishing it. When a cat scratches a couch, the property monitoring system 150 can flash lights repeatedly or change colors of the lights as a distraction.

In some implementations, the property monitoring system 150 can use machine learning to test various candidate actions and to learn individualized training methods for each pet or person. In some implementations, the property monitoring system 150 can use machine learning to test various combinations of frequencies of audios to determine the most effective training method for each pet. For instance, the system can test tones at various frequencies (e.g., 35 hz, 40 hz, 45 hz, 50 hz, . . . ) to arrive at the most effective tone played at 40 hz.

In some implementations, the property monitoring system 150 can dynamically vary the deterrence or reinforcement action using context information. The context information can represent other sensor data, other data, or both, about the property 102 when the behavior is detected. For example, when the owners are home at night, loud recordings of scolding the dog would be disruptive to sleep. Instead, the property monitoring system 150 can select ultrasonic tones in these scenarios as a way to influence animal behavior to reduce a likelihood of disrupting the owners' sleep. For example, the property monitoring system 150 can detect that the dog 132 is about to enter the bedroom 108 and in response, the property monitoring system 150 can play a sound 138 at a frequency that is only audible to animals such that a person sleeping in the bedroom 108 is not likely disturbed.

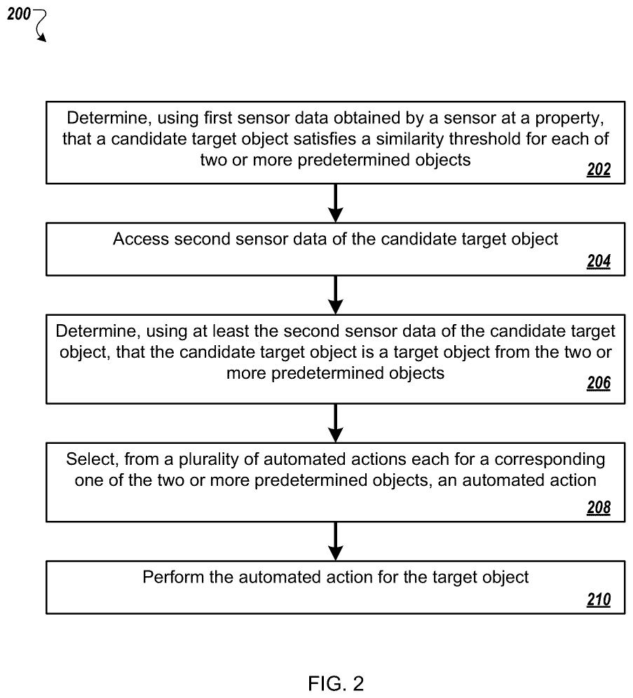

In some implementations, the property monitoring system 150 can select a target object from among two objects that have similar appearance, e.g., two dogs of the same kind, by using high resolution data, using a fine-grained object detection model, or a combination of both. The system can switch between different detection methods to more accurately determine an action to perform at a particular property while reducing computational resource usage. More details of detection among two objects that have similar appearance and performing a corresponding automated action in response to the detection is described in connection with FIG. 2, below.

For example, there can be two dogs, e.g., dog One and dog Two, that have similar appearance, e.g., two Labrador Retrievers. The target object data 158 can maintain data that can be used to identify the detailed differences between the two dogs. After detecting a dog 130 is in the living room 106 using an image captured by the camera 116, the property monitoring system 150 can perform a target selection process to determine whether the dog in the image is the dog One or dog Two. This can occur when the property monitoring system, e.g., the object detection engine 152, determines that a dog is depicted in an image, e.g., using a lower quality image. The property monitoring system 150 can then obtain additional image data, e.g., a higher quality image, provide the image to the fine-grained object detection model, e.g., implemented as part of the object detection engine 152, or both, to determine which of the two candidate objects, e.g., dog One and dog Two, is more likely depicted in the image. In some implementations, the property monitoring system 150 can use a detection model that has been trained to detect dog One and dog Two, instead of using a generic detection model that would simply detect dogs.

In some cases, the property monitoring system 150 can detect one or more candidate target objects at the property using a generic detector, e.g., a dog detector. For each detected candidate target object, the property monitoring system 150 can use a classifier that has been trained to differentiate different predetermined target objects, e.g., to differentiate dog One and dog Two (and possibly a third class of unknown dogs). In some implementations, the classifier can be a neural network that has been trained to process an input including a cropped image of the detected candidate target object. In some implementations, the classifier can use feature vectors extracted by the generic detector, another machine learning model, or a combination of both. The classifier can be a decision tree, a clustering-based classifier, a support vector machine (SVN), a neural network model, or any other appropriate machine learning method trained to perform classification using the feature vectors of the detected candidate target object.

In some examples, the property monitoring system 150 can obtain a facial image of the dog captured by a drone 134, a doorbell camera, or other camera at the property. Using the facial image of the dog, the property monitoring system 150 can determine that the dog 130 in the living room is the dog One, not the dog Two. In response to determining that the dog One is in the living room, the property monitoring system 150 can select an action that corresponds to the dog One, e.g., an action that is effective to get the dog One 130 off the couch, which action might not correspond to dog Two, e.g., might not be effective for dog Two 132. For example, the action can include calling the name of the dog One, or opening a backyard door 144 such that the dog One would be more likely to get off the couch 112.

In some implementations, the property monitoring system 150 can include historical data 156. The property monitoring system 150 can maintain the historical data 156 in a database. The historical data 156 can include historical sensor data. The historical sensor data can be data captured by sensors at the property 102 for which the system performs a corresponding action. In some implementations, the historical data 156 can include predetermined behavior data for a target object that was determined using historical sensor data. In some implementations, the property monitoring system 150 can automatically learn the desired or undesired behaviors from historical sensor data that represents human interactions with a target object. For example, the property monitoring system 150 can learn that dogs are not allowed in the bedroom 108 from historical videos captured by one or more cameras 117 and 124 that represent interactions between an owner of the dogs with the dogs 130 and 132, e.g., indicating that dogs are not allowed in the bedroom 108.

In some implementations, the property monitoring system 150 can determine the automated actions to train a target object by learning how a person trains the target object. This can reduce computational resource usage because the system need not try a number of different options to determine which action is most likely to work but can instead use data that represents successful actions performed at the property.

In some implementations, the property monitoring system 150 can use data based on user input to determine behavior for which an action should be performed, an automated action, or both. For instance, the property monitoring system 150 can receive input through a user interface that defines a region of interest, e.g., as one example of a zone. The region of interest can be for a region that an object should not enter, or should stay in. The data can indicate a behavior type, e.g., whether the behavior is allowed or should be prevented with respect to the region of interest. The data can indicate a type of the region, e.g., whether the object should stay in or not enter the region. The data can indicate one or more automated actions to perform when the object performs a behavior that does, or does not, satisfy the type of the region. For example, when the property monitoring system 150 detects a pet staying in a region in which the pet should stay, the property monitoring system 150 can perform an automated action to reinforce the pet's behavior. This can occur when the pet appears likely to try and leave the region but ultimately stays within the region. In some examples, when the property monitoring system 150 detects a pet attempting to leave a region of interest in which the pet should stay, the property monitoring system 150 can perform an automated action to deter the pet from leaving the region, e.g., apply a shock or another deterrent to the pet.

In implementations in which the property monitoring system 150 receives region of interest data, the property monitoring system 150 can determine the type of the region, the actions to perform, or both. For instance, the property monitoring system 150 can determine, by monitoring sensor data for the region of interest, whether the region is an exclusion region from which objects should be prevented from entering or an inclusion region for which objects should be prevented from leaving.

In some instances, a region of interest or another type of zone can be specific to a particular object. For instance, the property monitoring system 150 can maintain data that indicates that a region of interest is specific to a particular pet, e.g., that the particular pet is not allowed to enter the region of interest. The property monitoring system 150 can allow other pets, other than the particular pet, at the property 102 to enter the region of interest.

In some implementations, the property monitoring system 150 can perform an action to deter predetermined behavior without the target object performing the predetermined behavior. For instance, the property monitoring system 150 can determine, given a current behavior of the object, a likelihood that the object will perform the predetermined behavior. The property monitoring system 150 can determine whether the likelihood satisfies a likelihood threshold. If not, the property monitoring system 150 can determine to skip performing an automated action given the current behavior. If so, the property monitoring system 150 can perform a behavior to reduce a likelihood of the predetermined behavior. Some examples of this can include the property monitoring system 150 warning a pet when the pet shows an interest in another object with which the pet should not interact, e.g., a plant, or an area in which the pet should not enter.

In some examples, the property monitoring system 150 can determine an action to perform from multiple actions using captured sensor data. For instance, the property monitoring system 150, e.g., the action selection engine 154, can analyze sensor data that represents an object. The sensor data can be motion sensor data, video data, audio data, radar data, or any combination of these. The property monitoring system 150 can predict current behavior of the object using the sensor data. The property monitoring system 150 can determine whether a likelihood that the current behavior of the object is associated with predetermined behavior for which the property monitoring system 150 should perform an action. If so, the property monitoring system 150 can select a preliminary action to perform that is different than the action to perform upon detection of the predetermined behavior.

For example, the property monitoring system 150 can perform graduated actions from a sequence of actions upon detecting current behavior from a sequence of behaviors that result in a predetermined behavior that should be deterred. Although other systems might rely on proximity to a boundary or distance from a transmitter to, e.g., determine that a pet is attempting to leave an area in which they should stay, the use of the sensor data can enable the property monitoring system 150 to perform the graduated actions before the predetermined behavior is detected. This can increase a likelihood of deterrence of the predetermined behavior, an accuracy of the property monitoring system 150, or both. For instance, by using video data and data from other sensors that indicates not just proximity to a boundary, but whether a current behavior indicates that a pet might try to leave a region in which the pet should stay, the property monitoring system 150 can select a first action to perform that is different from a final action. The first action can be reinforcement or encouragement that the pet stay in the region. The final action can be a warning, shock, or another appropriate final action. The property monitoring system 150 can select, in some examples, one or more intermediate actions such as escalated warnings.

The property monitoring system 150 can include action data 160 that represent a plurality of actions. The property monitoring system 150 can maintain the action data 160 in a database. Each action in the action data 160 can represent an action that was performed as a result of a predetermined behavior of a target object, e.g., within a threshold time of the predetermined behavior of the target object. For example, the property monitoring system 150 can learn, from historical sensor data captured by the camera 117, that a person usually says “Stop” when the dog 130 enters the bedroom 108. The property monitoring system 150 can store action data 160 that includes playing a “Stop” sound 123 using a speaker 122 when the dog 130 enters the bedroom 108. The sound 123 can be a recording of the person, a generated recording given the phrases of the command, a prerecorded sound, or some other appropriate sound.

In some cases, the target object data 158 can include data for a person, e.g., a toddler or an older adult, that are monitored by the property monitoring system 150. The property monitoring system 150 can perform an automatic action after detecting a predetermined activity by the person. In some implementations, the system can deter a person from restricted areas, activities, or both. For example, if a toddler approaches a baby pool, a flashing light nearby can indicate they are doing something wrong. Because toddlers may be especially susceptible to distraction, if a child starts to climb up a table, a speaker across the room can start playing their favorite song to try to pull them away from the unsafe activity.

In some implementations, the property monitoring system 150 can encourage routines and healthy habits. For example, if it is past 10 am and an older adult has not been detected by video analytics to take their morning pills, the system can turn on a flashing red light in the kitchen to remind the older adult to take their morning pills. In some cases, if a healthy habit is to get up from a desk at least once every hour, the property monitoring system 150 can perform an auditory signal, a flashing light, or a combination of both, as a reminder that a person needs to get up and walk around after one hour has passed since the last time the person gets up from the desk.

The sensors at the property 102 can be any appropriate type of sensors, have any appropriate type of physical location state, or both. For instance, the sensors can include the one or more cameras 116, 117, and 124, the drone 134, the audio sensor, the motion sensor, the wi-fi sensing sensor, the radar, or any combination of these. The physical location state can include fixed, e.g., at a location, or moveable. A moveable sensor can be a sensor, such as a drone, that has a physical location that can change over time.

In some implementations, the property monitoring system 150 can determine to change a physical location of a sensor with a moveable physical location state. For instance, the property monitoring system 150 can maintain data that indicates first areas at the property 102 that include fixed sensors, second areas at the property 102 that include moveable sensors, third areas at the property 102 that do not include any sensors, or any combination of these. The areas can be any appropriate types of areas such as rooms or hallways. When the property monitoring system 150 determines that an area, or the property 102 generally, does not include any occupants, the property monitoring system 150 can determine whether to cause a moveable sensor to be positioned in the area. The property monitoring system 150 can compute a likelihood that the behavior of a target object in the area might satisfy a similarity criterion. When the likelihood satisfied a likelihood threshold, the property monitoring system 150 can determine to cause a moveable sensor to be positioned in the area. The property monitoring system 150 can cause the moveable sensor to be positioned in the area by sending an instruction to a robot that causes the robot to move the moveable sensor to the area, e.g., from another area. The sensor can be integrated into the robot, e.g., a robot with a camera attached, or separate from the robot, e.g., a camera that the robot can pick up and move or is otherwise affixed to the robot and optionally left in the area. This can increase monitoring accuracy, detection of monitored behavior, or both.

When the property monitoring system 150 determines that the area, or the property 102, includes or is likely to include an occupant, the property monitoring system 150 can determine to cause the moveable sensor to be removed from the area. For instance, the property monitoring system 150 can determine that a person is likely to enter the area, e.g., the room, and cause the moveable sensor to be removed from the area. The property monitoring system 150 can cause the removal prior to a predicted entry time frame in which the person is predicted to enter the area. This can reduce privacy concerns for monitoring the area.

The property monitoring system 150 can include any appropriate types of deterrent devices. Some examples can include speakers 120, 122; the drone 134, e.g., that includes one or more deterrent devices; another type of robot; a treat dispenser; or any appropriate combination of these. At least some of the deterrent devices can be incorporated into a sensor, e.g., one of the cameras 116, 117, 120, 122, 124 or another appropriate sensor. In some examples, at least some of the deterrent devices can be separate from any of the sensors, e.g., a microphone that is separate from a camera.

The deterrent devices can have any appropriate physical location state. Some of the deterrent devices can be fixed, e.g., a treat dispenser. Some of the deterrent devices can be movable, e.g., a deterrent device incorporated into or otherwise moveable by a robot. For example, the property monitoring system 150 might include a ceamra in a room into which the dog might enter, but the camera has no speakers and there are not any other deterrent devices in the room. In these examples, the property monitoring system 150 can send an instruction to a robot to cause the robot to move a speaker (and/or other stimulus device such as a treat dispenser) to the room to provide that functionality.

In some instances, the property monitoring system 150 can determine an action to perform using location data that indicates a location of one or more occupants, e.g., other occupants, at the property 102. For instance, when the property monitoring system 150 detects a pet performing a predetermined behavior in a room while a person is also in the room, the property monitoring system 150 can determine to emit an ultrasonic deterrent sound instead of a sound audible to people. This can include the property monitoring system 150 exchanging one deterrent device for another depending on the location and presence of people. For example, an ultrasonic device might be brought into the room if a person is there so that the audible deterrent has a reduced likelihood of affecting the person. In some examples, the property monitoring system 150 can cause the repositioning of a light emiting device, e.g., using a robot or adjusting a direction of the light, to increase a likelihood that the dog can see the light while reducing a likelihood that the person can, e.g., so the person cannot see the light.

The property monitoring system 150 is an example of a system implemented as computer programs on one or more computers 142 in one or more locations, in which the systems, components, and techniques described in this specification are implemented. A network 140, such as a local area network (“LAN”), wide area network (“WAN”), the Internet, or a combination thereof, connects the one or more computers 142 that implements the property monitoring system 150, the one or more sensors and devices at the property 102. The property monitoring system 150 can use a single computer or multiple computers operating in conjunction with one another, including, for example, a set of remote computers deployed as a cloud computing service.

The property monitoring system 150 can be implemented in a security system or another appropriate type of system. For instance, the property monitoring system 150 can include one or more sensors, such as one or more cameras, e.g., without being part of a security system.

The property monitoring system 150 can include several different functional components, including an object detection engine 152, and an action selection engine 154. The object detection engine 152, or the action selection engine 154, or a combination of these, can include one or more data processing apparatuses, can be implemented in code, or a combination of both. For instance, each of the object detection engine 152 and the action selection engine 154 can include one or more data processors and instructions that cause the one or more data processors to perform the operations discussed herein.

In some implementations, at least part of the property monitoring system 150, e.g., one or more components from the property monitoring system 150, can be implemented on at least one of the one or more sensors. For instance, the object detection engine 152 can be implemented on a camera or another sensor, on a backend system, e.g., in the cloud, or any combination of these. Another device that receives data from multiple sensors can implement the action selection engine 154. By implementing one or more components from the property monitoring system 150 on the sensor, the sensor can continue to perform operations when a network connection at the property 102 is not working.

The various functional components of the property monitoring system 150 can be installed on one or more computers as separate functional components or as different modules of the same functional component. For example, the components of the object detection engine 152 and the action selection engine 154 of the property monitoring system 150 can be implemented as computer programs installed on one or more computers in one or more locations that are coupled to each through a network. In cloud-based systems for example, these components can be implemented by individual computing nodes of a distributed computing system.

FIG. 2 is a flow diagram of a process 200 for the property monitoring system 150. For example, the process 200 can be used by the property monitoring system 150 from the environment 100.

The system determines, using first sensor data obtained by a sensor at a property, that a candidate target object satisfies a similarity threshold for each of two or more predetermined objects (202). For example, there can be multiple pets that look similar but correspond to different automated actions for the training of the pets. The system can determine that an object detected using sensor data satisfies similarity threshold for the multiple pets.

In some examples, the system might perform this operation only when the system maintains data for different actions for at least some of the two or more predetermined objects. For instance, the system can determine that the system maintains different data for two of the two or more predetermined objects. When the system analyzes sensor data that represents a candidate target object, the system can determine whether to perform operation 202 using the actions for the predetermined objects. In response to determining that the actions for the predetermined objects include at least two different actions, e.g., generally or for a particular type of action represented by the sensor data, the system can determine to perform operation 202.

The similarity threshold can be a threshold value for an object detection score generated by an object detector using the sensor data. The object detection score can indicate a likelihood that a predetermined object is detected in the sensor data. For a candidate target object detected in a sensor data, the system can generate an object detection score for each of the two or more predetermined objects. In some implementations, the system can have a different similarity threshold for each of the two or more predetermined objects, for each type of predetermined object, or a combination of both. In some implementations, the system can have the same similarity threshold for the two or more predetermined objects, e.g., by normalizing the object detection scores for the two or more predetermined objects.

For example, the threshold can be 0.8 for both dog One and dog Two at the property 102. If the object detector scores for dog One and dog Two are both larger than 0.8, the system can determine that a dog detected in a video can possibly be dog One or dog Two.

In some implementations, the system can store the similarity threshold in the target object data 158 that maintains the object detection models, features of the two or more predetermined objects, or a combination of both.

In response to determining, using the first sensor data obtained by the sensor at the property, that the candidate target object satisfies the similarity threshold for each of the two or more predetermined objects, the system accesses second sensor data of the candidate target object (204). The system can access the second sensor data in order to make more accurate object detection, e.g., determining which predetermined object the candidate target object is likely to be, compared to other systems.

In some implementations, the system can use the sensor data at the same resolution as used in step 202 but zoom in or focus on a region of interest where the two or more predetermined objects are different. For example, the sensor data can be an image with 1024×768 pixels that captures the entire body of a dog. The system can access a particular region of the image, e.g., 50×50 pixels that corresponds to the face of the dog.

In some implementations, the system can change to a different object detection model to perform the fine-grained object detection. For example, instead of using a model that differentiates cats, dogs, furniture and cars, the system can use an object detection model that is trained to differentiate different types of dogs, an object detection model that is trained to differentiate different dogs of the same type that was previously registered in the system, or an object detection model trained for the particular objects being differentiated. In some implementations, the system can update an existing model, e.g., retrain a model using existing training data, additional training data, or a combination of both. For example, the system can perform fine tuning on a model to generate a model that can differentiate different animals that have similar appearances.

In some implementations, when the candidate object satisfies the similarity threshold, the system can change a clustering process for how the system groups data that represents objects. In some implementations, the system can analyze the second sensor data. In some implementations, the system can train a feature extractor and once trained, the feature extractor can differentiate different objects by comparing the feature vectors of the different objects.

In some implementations, for different objects that have similar appearance (e.g., two yellow Labrador Retrievers whose appearance satisfies a similarity threshold), the initial feature vectors generated by an initial feature extractor might not sufficiently differentiate the different objects. In some implementations, a system, e.g., a machine learning training system, can retrain the feature extractor to generate feature vectors having larger distances between the different objects than the distances of the initial features vectors between the different objects. The system can be the property monitoring system 150 or another appropriate system with which the property monitoring system 150 communicates. In some implementations, the system can retrain a classifier that differentiates the different objects using the initial feature vectors. For example, for a machine learning model, such as a neural network model or a support vector machine, the system can retrain the classification output layers of the machine learning model, e.g., instead of or in addition to retraining the entire machine learning model, to better differentiate the different objects using the initial feature vectors. In some implementations, the system can test the feature extractor, the classifier, or both, using previously obtained training data depicting the different objects having similar appearance as part of an iterative training process. The training data can include ground truth labels differentiating the different objects, and in some cases, the ground truth labels can be determined using input from a user.

In some implementations, the system can obtain high resolution data of the candidate target object because the high resolution data can capture fine details that can be processed to differentiate objects that have similar appearances. For example, the property monitoring system 150 can obtain high resolution data of the dog 130 using an image captured by the drone 134. In some implementations, the system can process the high resolution data using the same object detection model as in step 202, using a different object detection model trained to process the high resolution data, or a combination of both.

In some implementations, the system can change a threshold value when there is a similarity. For example, when the system maintains data for only one object of a particular type, e.g., one dog or one dog of any particular breed or appearance, the similarity threshold in step 202 can be a first value that is more likely to be triggered given an action by a candidate target object. When the system detects another object of the particular type, the system can determine to adjust a value for the similarity threshold. For instance, in response to detecting another dog or another black dog, the system can change the similarity threshold to a higher threshold value such that the system can determine that the candidate target object is a target object from the two or more predetermined objects using the higher threshold value, e.g., reducing a risk of false positives given the similarity between the two objects.

The system determines, using at least the second sensor data of the candidate target object, that the candidate target object is a target object from the two or more predetermined objects (206). For example, the system can determine that the dog is dog One and is not dog Two.

In some implementations, the system can determine that the candidate target object is likely not one of the two or more predetermined objects using additional data obtained by the system. For example, the system can obtain data indicating that a guest code is generated for a guest who is expected to come to the property with a yellow Labrador Retriever. The system can proactively detect a guest yellow Labrador Retriever and can determine that a candidate object detected is not one of the dogs who live in the property 102.

In some examples, the two or more predetermined objects can include one yellow Labrador Retriever and a black Labrador Retriever who live in the property 102. The system can detect two yellow Labrador Retrievers using a video captured by a camera at the property, maybe because one of the dogs is a guest dog. In response to detecting two yellow Labrador Retrievers, the system can determine that this is an abnormal situation. The system can perform additional processing, e.g., redoing the clustering, using higher resolution images of the dogs, or a combination of these.

In response to determining that the candidate target object is the target object, the system selects, from a plurality of automated actions each for a corresponding one of the two or more predetermined objects, an automated action (208). For example, dog One and dog Two can respond to different automated actions. Dog One can respond to sound cues and dog Two can respond to visual cues. The system can select an automated action corresponding to the dog One in response to determining that the candidate target object is likely dog One.

The system performs the automated action for the target object (210). In some implementations, the system can determine that a behavior of the target object satisfies a similarity criterion for a predetermined behavior for the target object. In response to determining that the behavior of the target object satisfies a similarity criterion for the predetermined behavior, the system can cause performance of a training action corresponding to the predetermined behavior on the target object. For example, the predetermined behavior can be a desired or undesired behavior. The system can cause a performance of a training action to reinforce a desired behavior, to deter an undesired behavior, or a combination of both.

In some implementations, the system can automatically learn the desired or undesired behaviors from historical sensor data that represents human interactions with a target object and can determine the automated actions to train a target object by learning how a person trains the target object.

In some implementations, the system can maintain first data representing a predetermined behavior for a target object that was determined using historical sensor data obtained by one or more sensors at a property. The system can maintain second data representing an action that (i) was performed within a threshold time of the predetermined behavior of the target object, and (ii) was predicted to satisfy a correlation threshold that indicates that the action was likely performed as a result of the predetermined behavior. The system can determine, using the sensor data and the first data, that a behavior of the target object satisfies a similarity criterion for the predetermined behavior for the target object. In response to determining that the behavior of the target object satisfies the similarity criterion for the predetermined behavior, the system can cause, using the second data, performance of an automated action that represents the action that was performed within the threshold time of the predetermined behavior of the target object.

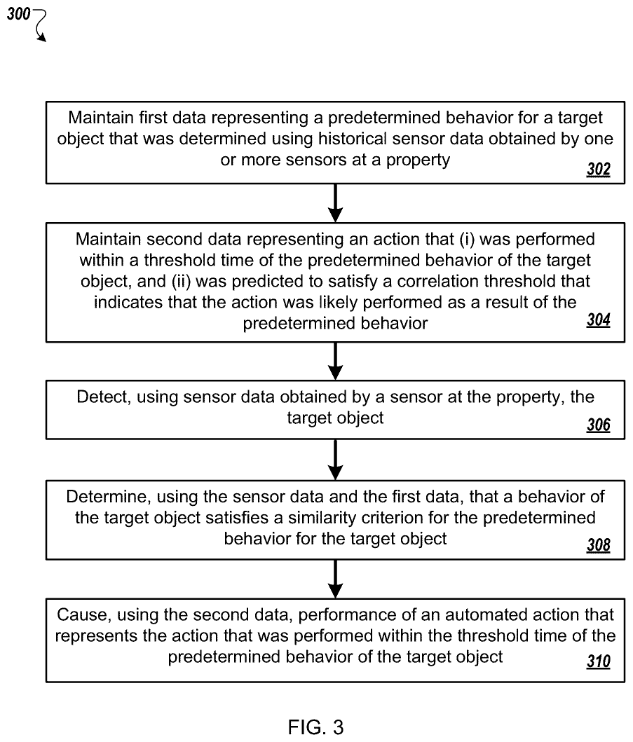

More details of automatically learning the desired or undesired behaviors from historical sensor data and determining the automated actions to train a target object by learning how a person trains the target object is described below in connection with FIG. 3.

The order of operations in the process 200 described above is illustrative only, and property monitoring system 150 can be performed in different orders. In some implementations, the process 200 can include additional operations, fewer operations, or some of the operations can be divided into multiple operations. For instance, the process 200 can include one or more operations described with respect to FIG. 3, below.

FIG. 3 is a flow diagram of a process 300 for the property monitoring system 150. For example, the process 300 can be used by the property monitoring system 150 from the environment 100.

The system maintains first data representing a predetermined behavior for a target object that was determined using historical sensor data obtained by one or more sensors at a property (302). In some implementations, the first data can include captioning data of sensor data, image segmentation data, rules for determining the predetermined behavior, a detection area for the predetermined behavior, or a combination of these.

For example, the property monitoring system 150 can use historical sensor data to determine a desired or undesired behavior of a target object. Using images or videos captured by a camera, the property monitoring system 150 can detect that a dog at the property 102 sometimes jumps on the couch 112 and a person at the property 102 often ask the dog to get off from the couch, and the property monitoring system 150 can determine that the dog being on the couch 112 is a predetermined behavior, e.g., an undesired behavior. Then, the system can store image captioning data representing the dog on the couch in historical data 156.

In some cases, the property monitoring system 150 can receive data, e.g., an image, from a user device of a user who identifies a predetermined behavior for a target object. The system can store the data representing the predetermined behavior in historical data 156. In some implementations, the historical data 156 can include historical sensor data, the first data representing the predetermined behavior, or a combination of both.

In some implementations, the system can maintain the first data representing default target objects, e.g., dogs and cats of any type, default actions, e.g., actions that are by default allowed or denied, or a combination of both default target objects and default actions. For example, the first data can represent a predetermined undesired behavior of biting on furniture performed by a dog.

The system maintains second data representing an action that (i) was performed within a threshold time of the predetermined behavior of the target object, and (ii) was predicted to satisfy a correlation threshold that indicates that the action was likely performed as a result of the predetermined behavior (304). In some implementations, the second data can include labeling data of sensor data, image segmentation data, rules for selecting the action from a plurality of actions, a detection area for the predetermined behavior, or a combination of these.

In some implementations, the system can obtain second data representing an action through user configuration and can save the second data in action data 160. In some implementations, the action data 160 can include the correlation threshold.

For example, the property monitoring system 150 can determine, using historical sensor data, that within a threshold time, e.g., 25 seconds, after the dog was on the couch, the owner of the dog said, “Get off the couch!”. The property monitoring system 150 can also determine that the owner saying “Get off the couch!” satisfies a correlation threshold that indicates the action was likely performed as a result of the dog being on the couch. For example, the owner usually did not say “Get off the couch!” to a cat that the owner had as a pet, but often said this to the dog. The system can compute a correlation value between the action and predetermined behavior and can compare the correlation with a correlation threshold. If the correlation value is larger than the correlation threshold, the system can determine that the action can be performed to train the dog, or this type of animal, to get off the couch. The system can save the second data representing the action in action data 160.

In some implementations, the system can obtain a response of the target object in response to the action within a time threshold. The system can determine whether the response of the target object within a time threshold of the action satisfies a threshold criterion, e.g., whether the action is likely effective in training the target object. If the system determines that the response of the target object given the action satisfies the threshold criterion, the system can store second data representing the action, e.g., saving the second data representing the action in action data 160. In some implementations, the action data 160 can include the threshold criterion. For example, if the dog got off the couch within a few seconds after the owner said “Get off the couch!”, the system can determine that the action of saying “Get off the couch!” is likely an effective action that can be automatically performed when the dog is determined to be on the couch.

In some implementations, the system can determine, using historical sensor data, that an action was performed by an entity within a threshold time of the predetermined behavior of the target object, and the action was predicted to satisfy a correlation threshold that indicates that the action was likely performed as a result of the predetermined behavior. The system can further determine whether to store data for the action using a characteristic of the entity. For example, if the age of the entity satisfies a threshold, e.g., a child entity, the system can determine not to maintain the action data because the action performed by a child may not be a desirable action to train a pet.

The system detects, using sensor data obtained by a sensor at the property, the target object (306). For example, the system can detect a target object using the object detection engine 152. In some implementations, the sensor data can be captured by the same sensor that captured the historical sensor data, by a different sensor, or a combination of both. In some implementations, the system can perform object selection from among two objects that have similar appearance, as described above in connection with FIG. 2, e.g., by performing one or more operations of the process 200.

The system determines, using the sensor data and the first data, that a behavior of the target object satisfies a similarity criterion for the predetermined behavior for the target object (308). For example, the similarity criterion is satisfied if a similarity measure between the behavior of the target object and the predetermined behavior for the target object satisfies a similarity threshold. In some implementations, the system can store the similarity criterion in the historical data 156 that saves the predetermined behavior. In some implementations, each predetermined behavior can have a corresponding similarity criterion.

In response to determining that the behavior of the target object satisfies the similarity criterion for the predetermined behavior, the system causes, using the second data, performance of an automated action that represents the action that was performed within the threshold time of the predetermined behavior of the target object (310).

The order of operations in the process 300 described above is illustrative only, and property monitoring system 150 can be performed in different orders. In some implementations, the process 300 can include additional operations, fewer operations, or some of the operations can be divided into multiple operations.

For situations in which the systems discussed here collect personal information about users, or may make use of personal information, the users may be provided with an opportunity to control whether programs or features collect personal information (e.g., information about a user's social actions or activities, a user's preferences, or a user's current location), or to control whether and/or how the system operates. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

In this specification, the term likely can mean that there is a likelihood that something might occur and that the likelihood satisfies a likelihood threshold. For instance, when determining that an object is likely depicted in an image, a system would determine a likelihood that the object is depicted in the image. The system would then determine whether the likelihood satisfies, e.g., is greater than or equal to, a likelihood threshold by comparing the two values. If so, the system determines that the object is likely depicted in the image. If not, the system determines that the object is not likely depicted in the image.

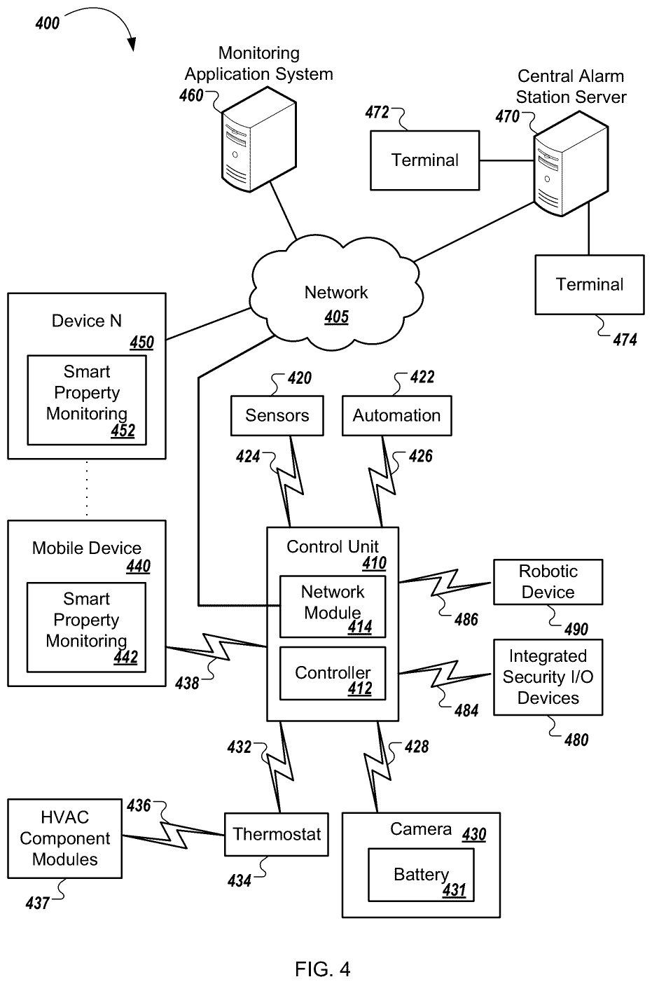

FIG. 4 is a diagram illustrating an example of an environment 400, e.g., for monitoring a property. The property can be any appropriate type of property, such as a home, a business, or a combination of both. The environment 400 includes a network 405, a control unit 410, one or more devices 440 and 450, a monitoring system 460, a central alarm station server 470, or a combination of two or more of these. In some examples, the network 405 facilitates communications between two or more of the control unit 410, the one or more devices 440 and 450, the monitoring system 460, and the central alarm station server 470. The property monitoring system 150 can include one or more components from the environment 400, e.g., can include the control unit 410. The property monitoring system 150 can include various components from the control unit 410, and components with which the control unit 410 communicates, with or without including the other systems and devices from the environment 400.

The network 405 is configured to enable exchange of electronic communications between devices connected to the network 405. For example, the network 405 can be configured to enable exchange of electronic communications between the control unit 410, the one or more devices 440 and 450, the monitoring system 460, and the central alarm station server 470. The network 405 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 405 can include multiple networks or subnetworks, each of which can include, for example, a wired or wireless data pathway. The network 405 can include a circuit-switched network, a packet-switched data network, or any other network able to carry electronic communications (e.g., data or voice communications). For example, the network 405 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VOIP”), or other comparable protocols used for voice communications. The network 405 can include one or more networks that include wireless data channels and wireless voice channels. The network 405 can be a broadband network.

The control unit 410 includes a controller 412 and a network module 414. The controller 412 is configured to control a control unit monitoring system, e.g., a control unit system, that includes the control unit 410. In some examples, the controller 412 can include one or more processors or other control circuitry configured to execute instructions of a program that controls operation of a control unit system. In these examples, the controller 412 can be configured to receive input from sensors, or other devices included in the control unit system and control operations of devices at the property, e.g., speakers, displays, lights, doors, other appropriate devices, or a combination of these. For example, the controller 412 can be configured to control operation of the network module 414 included in the control unit 410.

The network module 414 is a communication device configured to exchange communications over the network 405. The network module 414 can be a wireless communication module configured to exchange wireless, wired, or a combination of both, communications over the network 405. For example, the network module 414 can be a wireless communication device configured to exchange communications over a wireless data channel and a wireless voice channel. In some examples, the network module 414 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 414 can be a wired communication module configured to exchange communications over the network 405 using a wired connection. For instance, the network module 414 can be a modem, a network interface card, or another type of network interface device. The network module 414 can be an Ethernet network card configured to enable the control unit 410 to communicate over a local area network, the Internet, or a combination of both. The network module 414 can be a voice band modem configured to enable the alarm panel to communicate over the telephone lines of Plain Old Telephone Systems (“POTS”).

The control unit system that includes the control unit 410 can include one or more sensors 420. For example, the environment 400 can include multiple sensors 420. The sensors 420 can include a lock sensor, a contact sensor, a motion sensor, a camera (e.g., a camera 430), a flow meter, any other type of sensor included in a control unit system, or a combination of two or more of these. The sensors 420 can include an environmental sensor, such as a temperature sensor, a water sensor, a rain sensor, a wind sensor, a light sensor, a smoke detector, a carbon monoxide detector, or an air quality sensor, to name a few additional examples. The sensors 420 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 420 can include a radio-frequency identification (“RFID”) sensor that identifies a particular article that includes a pre-assigned RFID tag.

The control unit 410 can communicate with a module 422 and a camera 430 to perform monitoring. The module 422 is connected to one or more devices that enable property automation, e.g., home or business automation. For instance, the module 422 can connect to, and be configured to control operation of, one or more lighting systems. The module 422 can connect to, and be configured to control operation of, one or more electronic locks, e.g., control Z-Wave locks using wireless communications in the Z-Wave protocol. In some examples, the module 422 can connect to, and be configured to control operation of, one or more appliances. The module 422 can include multiple sub-modules that are each specific to a type of device being controlled in an automated manner. The module 422 can control the one or more devices using commands received from the control unit 410. For instance, the module 422 can receive a command from the control unit 410, which command was sent using data captured by the camera 430 that depicts an area. In response, the module 422 can cause a lighting system to illuminate an area to provide better lighting in the area, and a higher likelihood that the camera 430 can capture a subsequent image of the area that depicts more accurate data of the area.

The camera 430 can be an image camera or other type of optical sensing device configured to capture one or more images. For instance, the camera 430 can be configured to capture images of an area within a property monitored by the control unit 410. The camera 430 can be configured to capture single, static images of the area; video of the area, e.g., a sequence of images; or a combination of both. The camera 430 can be controlled using commands received from the control unit 410 or another device in the property monitoring system, e.g., a device 450.

The camera 430 can be triggered using any appropriate techniques, can capture images continuously, or a combination of both. For instance, a Passive Infra-Red (“PIR”) motion sensor can be built into the camera 430 and used to trigger the camera 430 to capture one or more images when motion is detected. The camera 430 can include a microwave motion sensor built into the camera which is used to trigger the camera 430 to capture one or more images when motion is detected. The camera 430 can have a “normally open” or “normally closed” digital input that can trigger capture of one or more images when external sensors detect motion or other events. The external sensors can include another sensor from the sensors 420, PIR, or door or window sensors, to name a few examples. In some implementations, the camera 430 receives a command to capture an image, e.g., when external devices detect motion or another potential alarm event or in response to a request from a device. The camera 430 can receive the command from the controller 412, directly from one of the sensors 420, or a combination of both.

In some examples, the camera 430 triggers integrated or external illuminators to improve image quality when the scene is dark. Some examples of illuminators can include Infra-Red, Z-wave controlled “white” lights, lights controlled by the module 422, or a combination of these. An integrated or separate light sensor can be used to determine if illumination is desired and can result in increased image quality.

The camera 430 can be programmed with any combination of time schedule, day schedule, system “arming state”, other variables, or a combination of these, to determine whether images should be captured when one or more triggers occur. The camera 430 can enter a low-power mode when not capturing images. In this case, the camera 430 can wake periodically to check for inbound messages from the controller 412 or another device. The camera 430 can be powered by internal, replaceable batteries, e.g., if located remotely from the control unit 410. The camera 430 can employ a small solar cell to recharge the battery when light is available. The camera 430 can be powered by a wired power supply, e.g., the controller's 412 power supply if the camera 430 is co-located with the controller 412.

In some implementations, the camera 430 communicates directly with the monitoring system 460 over the network 405. In these implementations, image data captured by the camera 430 need not pass through the control unit 410. The camera 430 can receive commands related to operation from the monitoring system 460, provide images to the monitoring system 460, or a combination of both.

The environment 400 can include one or more thermostats 434, e.g., to perform dynamic environmental control at the property. The thermostat 434 is configured to monitor temperature of the property, energy consumption of a heating, ventilation, and air conditioning (“HVAC”) system associated with the thermostat 434, or both. In some examples, the thermostat 434 is configured to provide control of environmental (e.g., temperature) settings. In some implementations, the thermostat 434 can additionally or alternatively receive data relating to activity at a property; environmental data at a property, e.g., at various locations indoors or outdoors or both at the property; or a combination of both. The thermostat 434 can measure or estimate energy consumption of the HVAC system associated with the thermostat. The thermostat 434 can estimate energy consumption, for example, using data that indicates usage of one or more components of the HVAC system associated with the thermostat 434. The thermostat 434 can communicate various data, e.g., temperature, energy, or both, with the control unit 410. In some examples, the thermostat 434 can control the environment, e.g., temperature, settings in response to commands received from the control unit 410.

In some implementations, the thermostat 434 is a dynamically programmable thermostat and can be integrated with the control unit 410. For example, the dynamically programmable thermostat 434 can include the control unit 410, e.g., as an internal component to the dynamically programmable thermostat 434. In some examples, the control unit 410 can be a gateway device that communicates with the dynamically programmable thermostat 434. In some implementations, the thermostat 434 is controlled via one or more modules 422.

The environment 400 can include the HVAC system or otherwise be connected to the HVAC system. For instance, the environment 400 can include one or more HVAC modules 437. The HVAC modules 437 can be connected to one or more components of the HVAC system associated with a property. A module 437 can be configured to capture sensor data from, control operation of, or both, corresponding components of the HVAC system. In some implementations, the module 437 is configured to monitor energy consumption of an HVAC system component, for example, by directly measuring the energy consumption of the HVAC system components or by estimating the energy usage of the one or more HVAC system components by detecting usage of components of the HVAC system. The module 437 can communicate energy monitoring information, the state of the HVAC system components, or both, to the thermostat 434. The module 437 can control the one or more components of the HVAC system in response to receipt of commands received from the thermostat 434.

In some examples, the environment 400 includes one or more robotic devices 490. The robotic devices 490 can be any type of robots that are capable of moving, such as an aerial drone, a land-based robot, or a combination of both. The robotic devices 490 can take actions, such as capture sensor data or other actions that assist in security monitoring, property automation, or a combination of both. For example, the robotic devices 490 can include robots capable of moving throughout a property using automated navigation control technology, user input control provided by a user, or a combination of both. The robotic devices 490 can fly, roll, walk, or otherwise move about the property. The robotic devices 490 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 490 can be robotic devices 490 that are intended for other purposes and merely associated with the environment 400 for use in appropriate circumstances. For instance, a robotic vacuum cleaner device can be associated with the environment 400 as one of the robotic devices 490 and can be controlled to take action responsive to monitoring system events.

In some examples, the robotic devices 490 automatically navigate within a property. In these examples, the robotic devices 490 include sensors and control processors that guide movement of the robotic devices 490 within the property. For instance, the robotic devices 490 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 490 can include control processors that process output from the various sensors and control the robotic devices 490 to move along a path that reaches the desired destination, avoids obstacles, or a combination of both. In this regard, the control processors detect walls or other obstacles in the property and guide movement of the robotic devices 490 in a manner that avoids the walls and other obstacles.

In some implementations, the robotic devices 490 can store data that describes attributes of the property. For instance, the robotic devices 490 can store a floorplan, a three-dimensional model of the property, or a combination of both, that enable the robotic devices 490 to navigate the property. During initial configuration, the robotic devices 490 can receive the data describing attributes of the property, determine a frame of reference to the data (e.g., a property or reference location in the property), and navigate the property using the frame of reference and the data describing attributes of the property. In some examples, initial configuration of the robotic devices 490 can include learning one or more navigation patterns in which a user provides input to control the robotic devices 490 to perform a specific navigation action (e.g., fly to an upstairs bedroom and spin around while capturing video and then return to a property charging base). In this regard, the robotic devices 490 can learn and store the navigation patterns such that the robotic devices 490 can automatically repeat the specific navigation actions upon a later request.

In some examples, the robotic devices 490 can include data capture devices. In these examples, the robotic devices 490 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 490 to take and store a biometric sample that can be used to identify the person (e.g., a biometric sample with DNA that can be used for DNA testing).

In some implementations, the robotic devices 490 can include output devices. In these implementations, the robotic devices 490 can include one or more displays, one or more speakers, any other type of output devices that allow the robotic devices 490 to communicate information, e.g., to a nearby user or another type of person, or a combination of these.

The robotic devices 490 can include a communication module that enables the robotic devices 490 to communicate with the control unit 410, each other, other devices, or a combination of these. The communication module can be a wireless communication module that allows the robotic devices 490 to communicate wirelessly. For instance, the communication module can be a Wi-Fi module that enables the robotic devices 490 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 490 to communicate with other devices, e.g., in or off the property. In some implementations, the robotic devices 490 can communicate with each other or with other devices of the environment 400 through the network 405.

The robotic devices 490 can include processor and storage capabilities. The robotic devices 490 can include any one or more suitable processing devices that enable the robotic devices 490 to execute instructions, operate applications, perform the actions described throughout this specification, or a combination of these. In some examples, the robotic devices 490 can include solid-state electronic storage that enables the robotic devices 490 to store applications, configuration data, collected sensor data, any other type of information available to the robotic devices 490, or a combination of two or more of these.

The robotic devices 490 can process captured data locally, provide captured data to one or more other devices for processing, e.g., the control unit 410 or the monitoring system 460, or a combination of both. For instance, the robotic device 490 can provide the images to the control unit 410 for processing. In some examples, the robotic device 490 can process the images to determine an identification of the items.

One or more of the robotic devices 490 can be associated with one or more charging stations. The charging stations can be located at a predefined home base or reference location in the property. The robotic devices 490 can be configured to navigate to one of the charging stations after completion of one or more tasks needed to be performed, e.g., for the environment 400. For instance, after completion of a monitoring operation or upon instruction by the control unit 410, a robotic device 490 can be configured to automatically fly to and connect with, e.g., land on, one of the charging stations. In this regard, a robotic device 490 can automatically recharge one or more batteries included in the robotic device 490 so that the robotic device 490 is less likely to need recharging when the environment 400 requires use of the robotic device 490, e.g., absent other concerns for the robotic device 490.

The charging stations can be contact-based charging stations, wireless charging stations, or a combination of both. For contact-based charging stations, the robotic devices 490 can have readily accessible points of contact to which a robotic device 490 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 490 can include a cover that opens to expose the electronic contact when the robotic device is charging and closes to cover and insulate the electronic contact when the robotic device 490 is in operation.

For wireless charging stations, the robotic devices 490 can charge through a wireless exchange of power. In these instances, a robotic device 490 needs only position itself closely enough to a wireless charging station for the wireless exchange of power to occur. In this regard, the positioning needed to land at a predefined home base or reference location in the property can be less precise than with a contact-based charging station. Based on the robotic devices 490 landing at a wireless charging station, the wireless charging station can output a wireless signal that the robotic device 490 receives and converts to a power signal that charges a battery maintained on the robotic device 490. As described in this specification, a robotic device 490 landing or coupling with a charging station can include a robotic device 490 positioning itself within a threshold distance of a wireless charging station such that the robotic device 490 is able to charge its battery.

In some implementations, one or more of the robotic devices 490 has an assigned charging station. In these implementations, the number of robotic devices 490 can equal the number of charging stations. In these implementations, the robotic devices 490 can always navigate to the specific charging station assigned to that robotic device 490. For instance, a first robotic device can always use a first charging station and a second robotic device can always use a second charging station.

In some examples, the robotic devices 490 can share charging stations. For instance, the robotic devices 490 can use one or more community charging stations that are capable of charging multiple robotic devices 490, e.g., substantially concurrently or separately or a combination of both at different times. The community charging station can be configured to charge multiple robotic devices 490 at substantially the same time, e.g., the community charging station can begin charging a first robotic device and then, while charging the first robotic device, begin charging a second robotic device five minutes later. The community charging station can be configured to charge multiple robotic devices 490 in serial such that the multiple robotic devices 490 take turns charging and, when fully charged, return to a predefined home base or reference location or another location in the property that is not associated with a charging station. The number of community charging stations can be less than the number of robotic devices 490.

In some instances, the charging stations might not be assigned to specific robotic devices 490 and can be capable of charging any of the robotic devices 490. In this regard, the robotic devices 490 can use any suitable, unoccupied charging station when not in use, e.g., when not performing an operation for the environment 400. For instance, when one of the robotic devices 490 has completed an operation or is in need of battery charge, the control unit 410 can reference a stored table of the occupancy status of each charging station and instructs the robotic device to navigate to the nearest charging station that has at least one unoccupied charger.

The environment 400 can include one or more integrated security devices 480. The one or more integrated security devices can include any type of device used to provide alerts based on received sensor data. For instance, the one or more control units 410 can provide one or more alerts to the one or more integrated security input/output devices 480. In some examples, the one or more control units 410 can receive sensor data from the sensors 420 and determine whether to provide an alert, or a message to cause presentation of an alert, to the one or more integrated security input/output devices 480.

The sensors 420, the module 422, the camera 430, the thermostat 434, the module 437, the integrated security devices 480, and the robotic devices 490, can communicate with the controller 412 over communication links 424, 426, 428, 432, 436, 438, 484, and 486. The communication links 424, 426, 428, 432, 436, 438, 484, and 486 can be a wired or wireless data pathway configured to transmit signals between any combination of the sensors 420, the module 422, the camera 430, the thermostat 434, the module 437, the integrated security devices 480, the robotic devices 490, or the controller 412. The sensors 420, the module 422, the camera 430, the thermostat 434, the module 437, the integrated security devices 480, and the robotic devices 490, can continuously transmit sensed values to the controller 412, periodically transmit sensed values to the controller 412, or transmit sensed values to the controller 412 in response to a change in a sensed value, a request, or both. In some implementations, the robotic devices 490 can communicate with the monitoring system 460 over network 405. The robotic devices 490 can connect and communicate with the monitoring system 460 using a Wi-Fi or a cellular connection or any other appropriate type of connection.

The communication links 424, 426, 428, 432, 436, 438, 484, and 486 can include any appropriate type of network, such as a local network. The sensors 420, the module 422, the camera 430, the thermostat 434, the robotic devices 490 and the integrated security devices 480, and the controller 412 can exchange data and commands over the network.

The monitoring system 460 can include one or more electronic devices, e.g., one or more computers. The monitoring system 460 is configured to provide monitoring services by exchanging electronic communications with the control unit 410, the one or more devices 440 and 450, the central alarm station server 470, or a combination of these, over the network 405. For example, the monitoring system 460 can be configured to monitor events (e.g., alarm events) generated by the control unit 410. In this example, the monitoring system 460 can exchange electronic communications with the network module 414 included in the control unit 410 to receive information regarding events (e.g., alerts) detected by the control unit 410. The monitoring system 460 can receive information regarding events (e.g., alerts) from the one or more devices 440 and 450.

In some implementations, the monitoring system 460 might be configured to provide one or more services other than monitoring services. In these implementations, the monitoring system 460 might perform one or more operations described in this specification without providing any monitoring services, e.g., the monitoring system 460 might not be a monitoring system as described in the example shown in FIG. 4.

In some examples, the monitoring system 460 can route alert data received from the network module 414 or the one or more devices 440 and 450 to the central alarm station server 470. For example, the monitoring system 460 can transmit the alert data to the central alarm station server 470 over the network 405.

The monitoring system 460 can store sensor and image data received from the environment 400 and perform analysis of sensor and image data received from the environment 400. Based on the analysis, the monitoring system 460 can communicate with and control aspects of the control unit 410 or the one or more devices 440 and 450.

The monitoring system 460 can provide various monitoring services to the environment 400. For example, the monitoring system 460 can analyze the sensor, image, and other data to determine an activity pattern of a person of the property monitored by the environment 400. In some implementations, the monitoring system 460 can analyze the data for alarm conditions or can determine and perform actions at the property by issuing commands to one or more components of the environment 400, possibly through the control unit 410.

The central alarm station server 470 is an electronic device, or multiple electronic devices, configured to provide alarm monitoring service by exchanging communications with the control unit 410, the one or more mobile devices 440 and 450, the monitoring system 460, or a combination of these, over the network 405. For example, the central alarm station server 470 can be configured to monitor alerting events generated by the control unit 410. In this example, the central alarm station server 470 can exchange communications with the network module 414 included in the control unit 410 to receive information regarding alerting events detected by the control unit 410. The central alarm station server 470 can receive information regarding alerting events from the one or more mobile devices 440 and 450, the monitoring system 460, or both.

The central alarm station server 470 is connected to multiple terminals 472 and 474. The terminals 472 and 474 can be used by operators to process alerting events. For example, the central alarm station server 470, e.g., as part of a first responder system, can route alerting data to the terminals 472 and 474 to enable an operator to process the alerting data. The terminals 472 and 474 can include general-purpose computers (e.g., desktop personal computers, workstations, or laptop computers) that are configured to receive alerting data from a computer in the central alarm station server 470 and render a display of information using the alerting data.

For instance, the controller 412 can control the network module 414 to transmit, to the central alarm station server 470, alerting data indicating that a sensor 420 detected motion from a motion sensor via the sensors 420. The central alarm station server 470 can receive the alerting data and route the alerting data to the terminal 472 for processing by an operator associated with the terminal 472. The terminal 472 can render a display to the operator that includes information associated with the alerting event (e.g., the lock sensor data, the motion sensor data, the contact sensor data, etc.) and the operator can handle the alerting event based on the displayed information. In some implementations, the terminals 472 and 474 can be mobile devices or devices designed for a specific function. Although FIG. 4 illustrates two terminals for brevity, actual implementations can include more (and, perhaps, many more) terminals.

The one or more devices 440 and 450 are devices that can present content, e.g., host and display user interfaces, audio data, or both. For instance, the mobile device 440 is a mobile device that hosts or runs one or more native applications (e.g., the smart property application 442). The mobile device 440 can be a cellular phone or a non-cellular locally networked device with a display. The mobile device 440 can include a cell phone, a smart phone, a tablet PC, a personal digital assistant (“PDA”), or any other portable device configured to communicate over a network and present information. The mobile device 440 can perform functions unrelated to the monitoring system, such as placing personal telephone calls, playing music, playing video, displaying pictures, browsing the Internet, and maintaining an electronic calendar.

The mobile device 440 can include a smart property application 442. The smart property application 442 refers to a software/firmware program running on the corresponding mobile device that enables the user interface and features described throughout. The mobile device 440 can load or install the smart property application 442 using data received over a network or data received from local media. The smart property application 442 enables the mobile device 440 to receive and process image and sensor data from the monitoring system 460.

The device 450 can be a general-purpose computer (e.g., a desktop personal computer, a workstation, or a laptop computer) that is configured to communicate with the monitoring system 460, the control unit 410, or both, over the network 405. The device 450 can be configured to display a smart property user interface 452 that is generated by the device 450 or generated by the monitoring system 460. For example, the device 450 can be configured to display a user interface (e.g., a web page) generated using data provided by the monitoring system 460 that enables a user to perceive images captured by the camera 430, reports related to the monitoring system, or both. Although FIG. 4 illustrates two devices for brevity, actual implementations can include more (and, perhaps, many more) or fewer devices.

In some implementations, the one or more devices 440 and 450 communicate with and receive data from the control unit 410 using the communication link 438. For instance, the one or more devices 440 and 450 can communicate with the control unit 410 using various wireless protocols, or wired protocols such as Ethernet and USB, to connect the one or more devices 440 and 450 to the control unit 410, e.g., local security and automation equipment. The one or more devices 440 and 450 can use a local network, a wide area network, or a combination of both, to communicate with other components in the environment 400. The one or more devices 440 and 450 can connect locally to the sensors and other devices in the environment 400.

Although the one or more devices 440 and 450 are shown as communicating with the control unit 410, the one or more devices 440 and 450 can communicate directly with the sensors and other devices controlled by the control unit 410. In some implementations, the one or more devices 440 and 450 replace the control unit 410 and perform one or more of the functions of the control unit 410 for local monitoring and long range, offsite, or both, communication.

In some implementations, the one or more devices 440 and 450 receive monitoring system data captured by the control unit 410 through the network 405. The one or more devices 440 and 450 can receive the data from the control unit 410 through the network 405, the monitoring system 460 can relay data received from the control unit 410 to the one or more devices 440 and 450 through the network 405, or a combination of both. In this regard, the monitoring system 460 can facilitate communication between the one or more devices 440 and 450 and various other components in the environment 400.

In some implementations, the one or more devices 440 and 450 can be configured to switch whether the one or more devices 440 and 450 communicate with the control unit 410 directly (e.g., through communication link 438) or through the monitoring system 460 (e.g., through network 405) based on a location of the one or more devices 440 and 450. For instance, when the one or more devices 440 and 450 are located close to, e.g., within a threshold distance of, the control unit 410 and in range to communicate directly with the control unit 410, the one or more devices 440 and 450 use direct communication. When the one or more devices 440 and 450 are located far from, e.g., outside the threshold distance of, the control unit 410 and not in range to communicate directly with the control unit 410, the one or more devices 440 and 450 use communication through the monitoring system 460.

Although the one or more devices 440 and 450 are shown as being connected to the network 405, in some implementations, the one or more devices 440 and 450 are not connected to the network 405. In these implementations, the one or more devices 440 and 450 communicate directly with one or more of the monitoring system components and no network (e.g., Internet) connection or reliance on remote servers is needed.

In some implementations, the one or more devices 440 and 450 are used in conjunction with only local sensors and/or local devices in a house. In these implementations, the environment 400 includes the one or more devices 440 and 450, the sensors 420, the module 422, the camera 430, and the robotic devices 490. The one or more devices 440 and 450 receive data directly from the sensors 420, the module 422, the camera 430, the robotic devices 490, or a combination of these, and send data directly to the sensors 420, the module 422, the camera 430, the robotic devices 490, or a combination of these. The one or more devices 440 and 450 can provide the appropriate interface, processing, or both, to provide visual surveillance and reporting using data received from the various other components.

In some implementations, the environment 400 includes network 405 and the sensors 420, the module 422, the camera 430, the thermostat 434, and the robotic devices 490 are configured to communicate sensor and image data to the one or more devices 440 and 450 over network 405. In some implementations, the sensors 420, the module 422, the camera 430, the thermostat 434, and the robotic devices 490 are programmed, e.g., intelligent enough, to change the communication pathway from a direct local pathway when the one or more devices 440 and 450 are in close physical proximity to the sensors 420, the module 422, the camera 430, the thermostat 434, the robotic devices 490, or a combination of these, to a pathway over network 405 when the one or more devices 440 and 450 are farther from the sensors 420, the module 422, the camera 430, the thermostat 434, the robotic devices 490, or a combination of these.

In some examples, the monitoring system 460 leverages GPS information from the one or more devices 440 and 450 to determine whether the one or more devices 440 and 450 are close enough to the sensors 420, the module 422, the camera 430, the thermostat 434, the robotic devices 490, or a combination of these, to use the direct local pathway or whether the one or more devices 440 and 450 are far enough from the sensors 420, the module 422, the camera 430, the thermostat 434, the robotic devices 490, or a combination of these, that the pathway over network 405 is required. In some examples, the monitoring system 460 leverages status communications (e.g., pinging) between the one or more devices 440 and 450 and the sensors 420, the module 422, the camera 430, the thermostat 434, the robotic devices 490, or a combination of these, to determine whether communication using the direct local pathway is possible. If communication using the direct local pathway is possible, the one or more devices 440 and 450 communicate with the sensors 420, the module 422, the camera 430, the thermostat 434, the robotic devices 490, or a combination of these, using the direct local pathway. If communication using the direct local pathway is not possible, the one or more devices 440 and 450 communicate with the sensors 420, the module 422, the camera 430, the thermostat 434, the robotic devices 490, or a combination of these, using the pathway over network 405.

In some implementations, the environment 400 provides people with access to images captured by the camera 430 to aid in decision-making. The environment 400 can transmit the images captured by the camera 430 over a network, e.g., a wireless WAN, to the devices 440 and 450. Because transmission over a network can be relatively expensive, the environment 400 can use several techniques to reduce costs while providing access to significant levels of useful visual information (e.g., compressing data, down-sampling data, sending data only over inexpensive LAN connections, or other techniques).

In some implementations, a state of the environment 400, one or more components in the environment 400, and other events sensed by a component in the environment 400 can be used to enable/disable video/image recording devices (e.g., the camera 430). In these implementations, the camera 430 can be set to capture images on a periodic basis when the alarm system is armed in an “away” state, set not to capture images when the alarm system is armed in a “stay” state or disarmed, or a combination of both. In some examples, the camera 430 can be triggered to begin capturing images when the control unit 410 detects an event, such as an alarm event, a door-opening event for a door that leads to an area within a field of view of the camera 430, or motion in the area within the field of view of the camera 430. In some implementations, the camera 430 can capture images continuously, but the captured images can be stored or transmitted over a network when needed.

Although FIG. 4 depicts the monitoring system 460 as remote from the control unit 410, in some examples the control unit 410 can be a component of the monitoring system 460. For instance, both the monitoring system 460 and the control unit 410 can be physically located at a property that includes the sensors 420 or at a location outside the property.

In some examples, some of the sensors 420, the robotic devices 490, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 410, the monitoring system 460, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A method comprising:
determining, using first sensor data obtained by a sensor at a property, that a candidate target object satisfies a similarity threshold for each of two or more predetermined objects;
in response to determining, using the first sensor data obtained by the sensor at the property, that the candidate target object satisfies the similarity threshold for each of the two or more predetermined objects, accessing second sensor data of the candidate target object;
determining, using at least the second sensor data of the candidate target object, that the candidate target object is a target object from the two or more predetermined objects;
in response to determining that the candidate target object is the target object, selecting, from a plurality of automated actions each for a corresponding one of the two or more predetermined objects, an automated action; and
performing the automated action for the target object.

2. The method of claim 1, comprising:
detecting an action performed by the candidate target object,
wherein determining, using the first sensor data, that the candidate target object satisfies the similarity threshold for each of two or more predetermined objects is responsive to detecting the action performed by the candidate target object.

3. The method of claim 1, wherein:
the first sensor data has a first resolution;
accessing the second sensor data of the candidate target object comprises accessing the second sensor data that has a second resolution that is different than the first resolution of the first sensor data; and
determining that the candidate target object is the target object from the two or more predetermined objects uses at least the second sensor data that has the second resolution that is different than the first resolution of the first sensor data.

4. The method of claim 1, wherein:
the first sensor data comprises the second sensor data and third sensor data;
accessing the second sensor data of the candidate target object comprises:
selecting, as the second sensor data, a proper subset of the first sensor data; and
determining to skip selecting the third sensor data; and
determining that the candidate target object is the target object from the two or more predetermined objects uses the second sensor data that is the proper subset of the first sensor data and does not use the third sensor data.

5. The method of claim 1, wherein:
determining that the candidate target object satisfies the similarity threshold for each of the two or more predetermined objects uses a first detection model; and
determining that the candidate target object is the target object from the two or more predetermined objects uses a second, different detection model that is a different model from the first detection model.

6. The method of claim 5, wherein the first detection model is trained to differentiate different types of objects than the second, different detection model.

7. The method of claim 1, wherein performing the automated action for the target object comprises:
determining that a behavior of the target object satisfies a similarity criterion for a predetermined behavior for the target object; and
in response to determining that the behavior of the target object satisfies a similarity criterion for the predetermined behavior, causing performance of a training action corresponding to the predetermined behavior on the target object.

8. The method of claim 1, wherein determining that the candidate target object is the target object from the two or more predetermined objects comprises:
determining, using at least the second sensor data of the candidate target object, whether the candidate target object is the target object from the two or more predetermined objects; and
determining that the candidate target object is the target object from the two or more predetermined objects.

9. One or more computer storage media encoded with instructions that, when executed by one or more computers, cause the one or more computers to perform operations comprising:
maintaining first data representing a predetermined behavior for a target object that was determined using historical sensor data obtained by one or more sensors at a property;
maintaining second data representing an action that (i) was performed within a threshold time of the predetermined behavior of the target object, and (ii) was predicted to satisfy a correlation threshold that indicates that the action was likely performed as a result of the predetermined behavior;
detecting, using sensor data obtained by a sensor at the property, the target object;
determining, using the sensor data and the first data, that a behavior of the target object satisfies a similarity criterion for the predetermined behavior for the target object; and
in response to determining that the behavior of the target object satisfies the similarity criterion for the predetermined behavior, causing, using the second data, performance of an automated action that represents the action that was performed within the threshold time of the predetermined behavior of the target object.

10. The media of claim 9, the operations comprising:
detecting, using first sensor data, behavior by the target object at a first time;
detecting, using second sensor data, the action performed by a person at the property within the threshold time of the first time;
in response to detecting the action performed by the person at the property within the threshold time of the first time, predicting that the action and the behavior satisfy the correlation threshold; and
in response to predicting that the action and the behavior satisfy the correlation threshold, updating the first data, the second data, or both, to include association data that associates the behavior with the action.

11. The media of claim 10, the operations comprising:
detecting a response by the target object after the action was performed by the person at the property; and
determining, using the response, whether the action performed by the person satisfies a threshold effectiveness criterion, wherein:
updating the first data, the second data, or both, is responsive to determining that the action performed by the person satisfies a threshold effectiveness criterion.

12. The media of claim 11, wherein determining, using the response, whether the action performed by the person satisfies a threshold effectiveness criterion is responsive to predicting that the action and the behavior satisfy the correlation threshold.

13. The media of claim 10, the operations comprising:
receiving data indicating user input defining a region of interest for analysis,
wherein detecting the behavior by the target object at the first time uses the region of interest.

14. The media of claim 9, the operations comprising:
determining third data defining a region of interest;
determining fourth data defining a rule for the region of interest that indicates either an allowed behavior or behavior that should be prevented;
determining fifth data indicating an action to perform upon detection of the allowed behavior or the behavior that should be prevented;
updating the first data using the third data and the fourth data; and
updating the second data using the fifth data.

15. The media of claim 9, wherein the sensor comprises a moveable sensor, the operations comprising:
detecting movement of a person at the property;
determining to change a location of the moveable sensor at the property in response to detecting the movement of the person at the property; and
sending, to a device, an instruction to cause the change to the location of the moveable sensor at the property.

16. The media of claim 15, wherein:
detecting the movement of the person at the property comprises determining that the person left an area at the property;
determining to change the location of the moveable sensor at the property is responsive to determining that the person left the area at the property;
sending the instruction causes the moveable sensor to move to the area of the property; and
detecting the target object comprises detecting, in the area at the property and using the sensor data obtained by the moveable sensor in the area of the property, the target object.

17. The media of claim 15, wherein:
detecting the target object comprises detecting, in an area at the property and using the sensor data obtained by the moveable sensor in the area of the property, the target object;
detecting the movement of the person at the property comprises predicting that the person is likely to enter an area at the property;
determining to change the location of the moveable sensor at the property is responsive to predicting that the person is likely to enter the area at the property; and
sending the instruction causes the moveable sensor to leave the area of the property is performed after detecting the target object using the moveable sensor and before the person is predicted to enter the area at the property.

18. The media of claim 17, wherein sending the instruction comprises sending the instruction to a robot to cause the robot to move the moveable sensor from the area at the property.

19. The media of claim 9, the operations comprising:
determining, using sensor data obtained by a sensor at a property, that a candidate target object satisfies a similarity threshold for each of two or more predetermined objects;
in response to determining, using the sensor data obtained by the sensor at the property, that the candidate target object satisfies the similarity threshold for each of the two or more predetermined objects, accessing second sensor data of the candidate target object;
determining, using at least the second sensor data of the candidate target object, that the candidate target object is a target object from the two or more predetermined objects;
in response to determining that the candidate target object is the target object, selecting, from a plurality of automated actions each for a corresponding one of the two or more predetermined objects, an automated action; and
performing the automated action for the target object.

20. A system comprising one or more computers and one or more storage devices on which are stored instructions that are operable, when executed by the one or more computers, to cause the one or more computers to perform operations comprising:
determining, using first sensor data obtained by a sensor at a property, that a candidate target object satisfies a similarity threshold for each of two or more predetermined objects;
in response to determining, using the first sensor data obtained by the sensor at the property, that the candidate target object satisfies the similarity threshold for each of the two or more predetermined objects, accessing second sensor data of the candidate target object;
determining, using at least the second sensor data of the candidate target object, that the candidate target object is a target object from the two or more predetermined objects;
in response to determining that the candidate target object is the target object, selecting, from a plurality of automated actions each for a corresponding one of the two or more predetermined objects, an automated action; and
performing the automated action for the target object.
